(19) United States
(12) Patent Application Publication
(10) Pub. No.: US 2026/0204817 A1
(43) Pub. Date: Jul. 16, 2026

(54) SUPPORT STRUCTURES FORMED FROM ADHESIVE TO MECHANICALLY SUPPORT CONNECTORS ON PRINTED CIRCUIT BOARDS

(71) Applicant: Cisco Technology, Inc., San Jose, CA (US)

(72) Inventors: Christopher Zieman, Chapel Hill, NC (US); Danny Chau, Fremont, CA (US); Tae-Kyu Lee, Livermore, CA (US)

(21) Appl. No.: 19/182,728

(22) Filed: Apr. 18, 2025

Related U.S. Application Data
(60) Provisional application No. 63/743,724, filed on Jan. 10, 2025.

(51) Int. Cl. H01R 12/71; C09J 5/00

(52) U.S. Cl. CPC H01R 12/716; C09J 5/00

(57) ABSTRACT

In one embodiment, a method includes aligning a printed circuit board (PCB) and a connector, and dispensing a plurality of layers of an adhesive material, wherein the plurality of layers of the adhesive material form a structure that attaches the PCB and the connector, wherein the plurality of layers of the adhesive material cooperate with the PCB and the connector to define a clearance or a void. The method also includes curing the plurality of layers of the adhesive material to harden the structure.

### CROSS-REFERENCE TO RELATED APPLICATION

This patent application claims the benefit of priority under 35 U.S.C. § 119 to U.S Provisional Patent Application No. 63/743,724, filed January 10, 2025, and entitled “SUPPORT STRUCTURES FORMED FROM ADHESIVE TO MECHANICALLY SUPPORT CONNECTORS ON PRINTED CIRCUIT BOARDS,” which is incorporated herein by reference in its entirety.

### TECHNICAL FIELD

The present disclosure relates to printed circuit board assemblies.

### BACKGROUND

Printed circuit boards (PCBs) generally include interfaces such as interconnects which enable components to be affixed thereon. A PCB may include conductive pads that enable components to be mechanically attached to and/or electrically connected to the PCB. A PCB may also include drilled through-holes, as for example vias, that also enable components to be mechanically attached and/or electrically connected to the PCB. Components may be attached to or connected to a PCB using press fit pins, soldering, and/or compression contacts.

The increased ability to interconnect cards and other components to a PCB is rendering it necessary for PCB assemblies to support increasing card weights and new mating compression systems that support higher signal speeds. As signal speeds that are supported by PCBs increase, signal integrity performance expectations are also increasing.

### BRIEF DESCRIPTION OF THE DRAWINGS

FIG. 1A is a block diagram representation of a first side view of a printed circuit board (PCB) assembly that includes an adhesive layer structure or stack in accordance with an embodiment.

FIG. 1B is a block diagram representation of a second side view of a PCB assembly that includes an adhesive layer structure or stack, e.g., PCB assembly 150 of FIG. 1A, in accordance with an embodiment.

FIG. 2A is a block diagram representation of a first side view of a PCB assembly that includes an adhesive layer structure or stack with offset layers in accordance with an embodiment.

FIG. 2B is a block diagram representation of a second side view of a PCB assembly that includes an adhesive layer structure or stack with offset layers, e.g., PCB assembly 250 with offset layers 262a-c of FIG. 2A, that have substantially the same lengths relative to a y-axis in accordance with an embodiment.

FIG. 2C is a block diagram representation of a second side view of a PCB assembly that includes an adhesive layer structure or stack with offset layers, e.g., PCB assembly with offset layers 262a-c of FIG. 2A, in which the offset layers include layers of different lengths relative to a y-axis in accordance with an embodiment.

FIG. 3 is a block diagram representation of a first side view of a PCB assembly that includes an adhesive layer structure or stack that defines a void around a feature of the PCB assembly in accordance with an embodiment.

FIG. 4 is a process flow diagram which illustrates a method of creating a PCB assembly in accordance with an embodiment.

FIG. 5 is a process flow diagram which illustrates a method of creating a PCB assembly that includes an adhesive layer structure or stack that defines a void in accordance with an embodiment.

FIG. 6 is a block diagram representation of a PCB assembly that includes a connector with a protrusion feature, e.g., a lip or a shelf, that is configured to provide structure to an adhesive layer structure or stack in accordance with an embodiment.

FIG. 7 is a process flow diagram which illustrates a method of creating a PCB assembly that includes an adhesive layer stack with structure provided by a protrusion on a connector in accordance with an embodiment.

FIG. 8 is a diagrammatic top view representation of a PCB assembly plurality of PCBs and a plurality of connectors attached to the PCBs using adhesive layer structures in accordance with an embodiment. FIG. 9A is a diagrammatic top view representation of a PCB that includes an adhesive layer structure or stack in accordance with an embodiment.

FIG. 9A is a diagrammatic representation of a PCB assembly that includes a PCB and an adhesive layer structure or stack in accordance with an embodiment.

FIG. 9B is a diagrammatic side view representation of a PCB assembly that includes a PCB and an adhesive layer structure or stack, e.g., PCB 954 of FIG. 9A, attached to a connector in accordance with an embodiment.

FIG. 10 illustrates a hardware block diagram of a computing device that may include a PCB assembly referred to herein in connection with the techniques depicted in FIGS. 1A, 1B, 2A, 2C, 3-8, 9A and 9B.

### DESCRIPTION OF EXAMPLE EMBODIMENTS

### Overview

Presented herein are techniques to create a printed circuit board (PCB) assembly that includes a PCB and a connector that utilizes a three-dimensional structure created from an adhesive material to secure the connector to the PCB. A three-dimensional structure, as for example a stack, that is arranged to substantially affix a connector to a PCB is created from a plurality of layers of temperature-stable, relatively highly viscous adhesive, as for example an adhesive that has a viscosity capable of creating three-dimensional structures through multiple dispense layers. The use of a stack of adhesive layers to connect a connector to a PCB provides relatively strong structural support for the connector substantially without utilizing screw hold down features, mechanical support brackets, and/or large soldered post holes which occupy space on the PCB. While the structural support provided by screw hold down features may be effective to provide structural support for connectors with respect to PCBs, screw hold down features occupy precious routing channel space inside PCBs, and are suspectable to loosening during thermal cycling.

According to one aspect, a method includes aligning a PCB and a connector, and dispensing a plurality of layers of an adhesive material, wherein the plurality of layers of the adhesive material form a structure that attaches the PCB and the connector, wherein the plurality of layers of the adhesive material cooperate with the PCB and the connector to define a clearance or a void. The method also includes curing the plurality of layers of the adhesive material to harden the structure.

In accordance with another aspect, an apparatus includes a PCB, a connector, and a structure. The structure is configured to couple the connector to the PCB, wherein the structure includes a plurality of layers formed from an adhesive material, and wherein the plurality of layers is arranged to cooperate with the connector and the PCB to define a clearance, e.g., a gap or a void in the structure.

In accordance with still another aspect, an apparatus includes a PCB, the PCB having a first feature. The apparatus also includes a connector and a three-dimensional structure configured to support the connector on the PCB. The structure includes a plurality of adhesive layers, and wherein the plurality of adhesive layers is arranged to define a void that is arranged over the first feature.

### Example Embodiments

As signal speeds that are supported by printed circuit boards (PCBs) increase, signal integrity performance expectations associated with PCBs are also increasing. For example, interconnects of PCBs are increasingly using smaller press fit pins, soldered down contacts, and compression contacts in order to support a continued push towards higher density solutions. Geometries on PCBs relating, for example, to vias and plated through holes (PTHs), that meet signal integrity performance expectations generally result in less connector to PCB signal joint retention support when connectors are attached to PCBs. Joint interface geometries, as for example a press fit pin width and length with a corresponding PCB finished hole size, that may meet signal integrity performance expectations generally result in less connector-to-PCB signal joint retention support when connectors are attached to PCBs. Typically, modular interconnect connectors such as those used to connect a card to a PCB, e.g., to form a PCB assembly, are electrically connected to the PCB, and also effectively ensure that a signal joint does not move when subjected to forces related to the weight of the PCB assembly, the handling of the PCB assembly, misuse of the PCB assembly, mating loads associated with the PCB assembly, transportation of the PCB assembly, and/or shocks and vibrations.

Due to connector to PCB mechanical support expectations within a PCB assembly, features such as screw hold down features, mechanical support brackets, and/or relatively large, soldered post holes are often incorporated to ensure joint integrity within the PCB assembly. Such features occupy space in a PCB assembly, and features such as mechanical support brackets may also be expensive. Further, when mechanical support structures such as brackets or screws are applied, a constant external force may be applied to maintain bonding stability. The addition of such a constant external force may also affect a pin to PCB connection, and further cause deformation in micro-pins, which will generally have a negative effect on signal integrity, and may cause a loss in mechanical contact stability. Therefore, the use of features such as brackets and screws to provide mechanical support within a PCB assembly may not be efficient.

Further, high density and high speed signal routing out of the interconnects in a PCB assembly is increasingly challenging, and the addition of holes in a PCB, as for example to support connectors, limits routing space on the PCB. As such, adding holes in a PCB to provide mechanical support for interconnects may not be viable in some situations due to a lack of available space on the PCB.

In one embodiment, a bond process for affixing or bonding connectors to a PCB using a three-dimensional structure created from layers of adhesive material provides mechanical hold down support of the connectors to the PCB. Adhesive layers effectively do not occupy routing channel space in the PCB, and may be provided in areas of the PCB that may otherwise be inaccessible to traditional screw hold down features, e.g., traditional mechanical screw supports. Temperature stable, relatively high viscosity adhesives may be used to create the adhesive layers which may be configured to form an overall three-dimensional structure with a desired size and shape. Further, the overall three-dimensional structure may be formed such that a space, e.g., a clearance or a void, may be defined by the three-dimensional structure to provide an area on the PCB that is not in contact with the three-dimensional structure.

A three-dimensional structure that bonds a connector to a PCB may be created by stacking, e.g., vertically stacking, layers of adhesive material relative to at least a z-axis. The vertical stacking of adhesive material may enable a relatively weak connector feature of the connector, as for example a relatively weak connector feature towards the bottom of a connector, to essentially be bypassed such that a relatively strong connector feature of the connector, as for example a relatively strong connector feature located above the relatively weak connector feature, may be used to attach the connector to the stack and, hence, the PCB. That is, stronger structural support may be provided by a structure or stack that is formed from the vertical stacking of adhesive material which facilitates support of a connector at a position on the connector that may have a stronger connector feature. Further, the use of a three-dimensional structure formed from adhesive material allows for signal integrity to meet performance expectations, while providing mechanical robustness. Hardening of the adhesive structure provides stability to the connector substantially without applying external forces, and enables signal integrity support.

In addition to, or in lieu, of including vertically stacked layers of adhesive material, a three-dimensional structure may include horizontally stacked layers of adhesive material. Horizontally stacked layers of adhesive material may generally include layers which are adjacent to, and in physical contact with, each other along at least one of an x-axis and a y-axis.

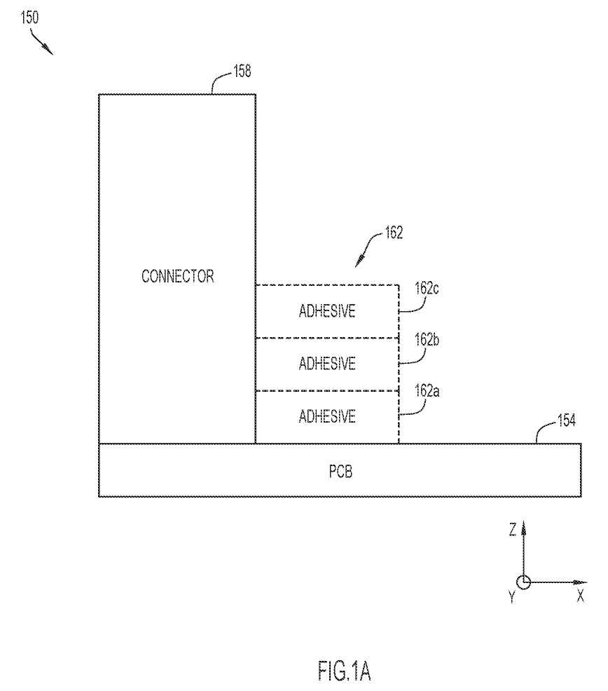

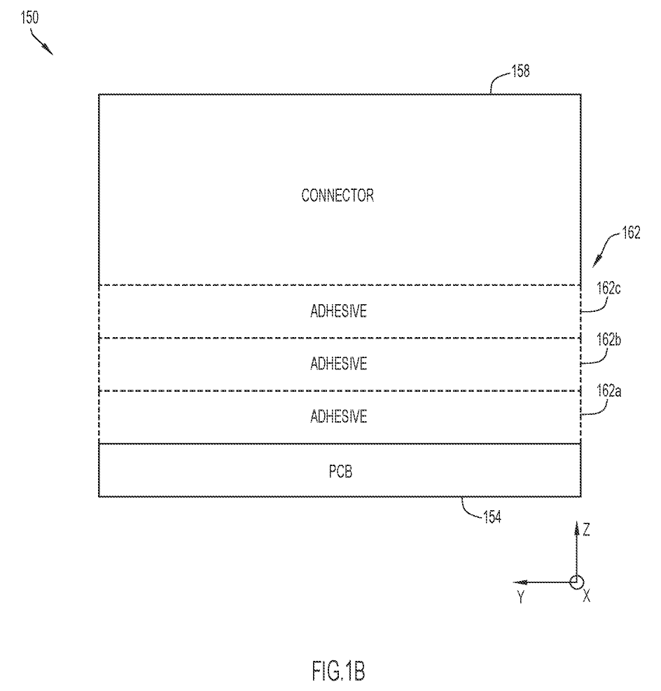

Referring initially to FIGS. 1A and 1B, a PCB assembly that includes an adhesive layer structure or stack will be described in accordance with an embodiment. A PCB assembly 150 includes a PCB 154 and a connector 158 that is structurally supported on PCB 154 by a three-dimensional structure 162 or stack that is formed from a plurality of adhesive layers 162a-c. It should be appreciated that in some situations, connector 158 may already be attached to PCB 154 when structure 162 is formed, and structure 162 may be arranged to provide additional support for connector 158.

Adhesive layers 162a-c may be formed such that adhesive layers 162a-c are stacked to form an overall three-dimensional block or box structure. It should be appreciated that while adhesive layers 162a-c are shown as being substantially stacked relative to a z-axis to form a three-dimensional box structure, the structure formed is not limited to being a box structure. Further, adhesive layers 162a-c may additionally, or alternatively, be substantially stacked relative to an x-axis and/or a y-axis.

In general, adhesive layers 162a-c that form structure 162 may be formed from, but are not limited to being formed from, a temperature-stable, relatively high viscosity adhesive such as glue or epoxy. A suitable adhesive may be selected based on the materials that the adhesive is intended to join. Adhesive layers 162a-c may generally be formed from the same adhesive, although it should be appreciated that each adhesive layer 162a-c may be formed from a different adhesive.

First adhesive layer 162a is formed on a surface of PCB 154, and abuts against a surface of connector 158. That is, first adhesive layer 162a is a first PCB attach layer, or an adhesive layer that is formed substantially directly on, or otherwise in contact with, PCB 154. Second adhesive layer 162b is formed on, e.g., atop, first adhesive layer 162a, and abuts against a surface of connector 158. Third adhesive layer 162c is formed on second adhesive layer 162b, and abuts against a surface of connector 158. In one embodiment, adhesive layers 162a-c are all attached to, or otherwise in contact with, a surface of connector 158, and cooperate to provide structural support to connector 158 that enables connector 158 to be supported on or against PCB 154. In some instances, first adhesive layer 162a and second adhesive layer 162b may be substantially the same layer, as for example when an adhesive material and the material from which PCB 154 is formed may relatively easily bond together. While the thicknesses of layers 162a-c may vary, in one embodiment, first adhesive layer 162a may be relatively thin, e.g., may have a thickness of approximately 0.5 millimeters, while second adhesive layer 162b may be thicker, e.g., may have a thickness that is greater than approximately one millimeter or in a range of between approximately 1.5 and approximately 1.9 millimeters.

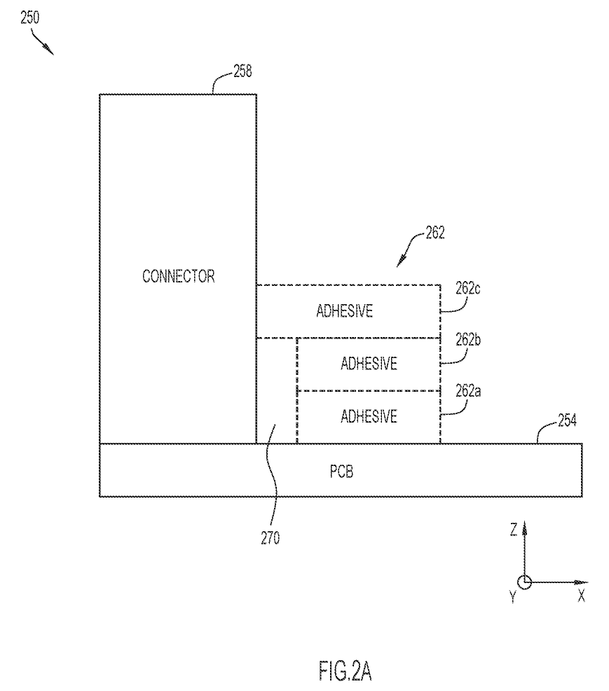

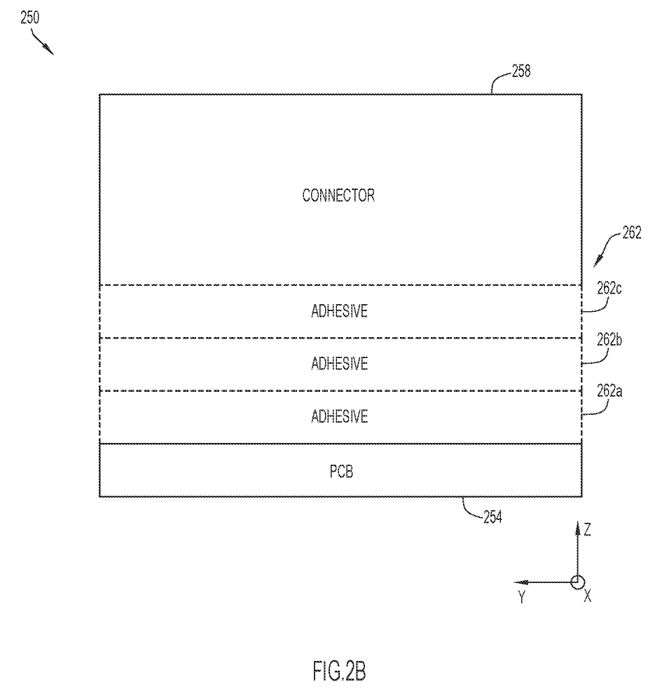

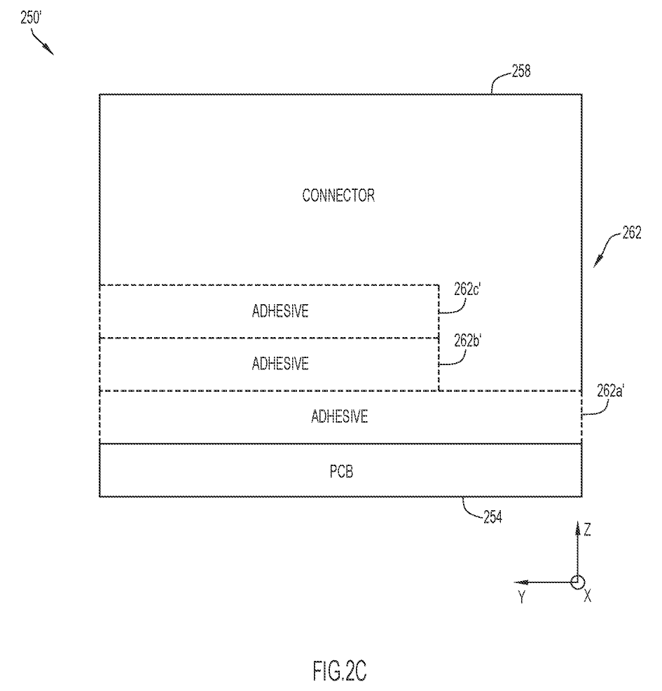

While structure 162 may essentially be formed as a block or as a box-like structure, structures that or formed from layers of adhesive are not limited to being blocks or box-like structures. By way of example, a three-dimensional structure formed from adhesive layers may be formed from layers arranged to enable an opening, void, or substantially empty space to be defined by the layers of the three-dimensional structure. That is, a three-dimensional structure that supports a connector with respect to a PCB may include offset adhesive layers. FIG. 2A is a diagrammatic first side view representation of a PCB assembly with offset layers in an adhesive layer stack, and FIG. 2B is a diagrammatic second side view representation of the PCB assembly with offset layers in the adhesive layer stack in accordance with an embodiment. A PCB assembly 250 may include a PCB 254 and a connector 258. A three-dimensional structure 262 or stack is created from adhesive or dispense layers 262a-c. While layer 262a, layer 262b, and layer 262c have been shown, it should be understood that the number of layers in structure 262 may vary widely. Each layer 262a-c may have a different size or shape, and each layer 262a-c may be stacked such that layers 262a-c may be offset with respect to each other relative to at least one axis.

Layer 262a is adhered to PCB 254, while layer 262b is adhered to layer 262a and to layer 262c. Layer 262c is adhered to layer 262b, and is positioned with an offset relative to an x-axis such that a part of layer 262c overhangs layer 262b to define a gap, a pocket, a space, and opening, or a void 270. Void 270 is partially defined by structure 262, connector 258, and PCB 254 such that void 270 is effectively included in structure 262. As will be appreciated by those skilled in the art, void 270 may be included to enable a part of PCB 254 to remain free of the adhesive material used to create layers 262a-c. For example, a press-fit pin hole or pad area may be located on PCB 254 under void 270, and void 270 may be defined to substantially prevent adhesive material ingress, e.g., to substantially prevent adhesive material included in structure 262 from entering the press-fit pin hole or covering the pad area.

Layer 262c affixes connector 258 to structure 262, and provides structural support to connector 258. In one embodiment, because layer 262c is relatively high on structure 262 relative to a z-axis, the strength of the structural support provided to connector 258 is greater than would be provided by, for example, layer 262b and layer 262a if layer 262c were not part of structure 262 and either layer 262b or layer 262a were in contact with connector 258. For example, structure 262 may be formed with layers 262a-c sized to be tall enough relative to the z-axis to effectively extend a weaker feature (not shown) positioned in void 270 to bond to connector 258, or a particular stronger feature (not shown) on connector 258. It should be appreciated that although layer 262b is not shown as being in contact with connector 258, layer 262b may instead be in contact with connector 258. The relative dimensions and orientations of layers 262a-c may vary depending upon properties of connector 258 and an overall application for which PCB assembly 250 is to be used. For example, in an embodiment for which pins are to be substantially bypassed, layer 262b and/or layer 262c may attach above a particular feature (not shown) of connector 258 with a sufficient amount of surface area for a desired strength.

While layers 262a-c have been shown as having substantially the same length relative to a y-axis, it should be appreciated that layers 262a-c are not limited to being of substantially the same length. In general, the length of each layer 262a-c, as well as the width and the height of each layer 262a-c, may vary. FIG. 2C is a block diagram representation of a second side view of a PCB assembly that includes an adhesive layer stack with offset layers, e.g., PCB assembly with offset layers 262a-c of FIG. 2A, in which the offset layers include layers of different lengths relative to a y-axis in accordance with an embodiment. As shown, in PCB assembly 250’, a first adhesive layer 262a’ may have a longer length relative to the y-axis than a second adhesive layer 262b’ and third adhesive layer 262c’. While second adhesive layer 262b’ and third adhesive layer 262c’ have been shown as having approximately the same length relative to the y-axis. It should be appreciated that second adhesive layer 262b’ and third adhesive layer 262c’ may have different lengths relative to the y-axis.

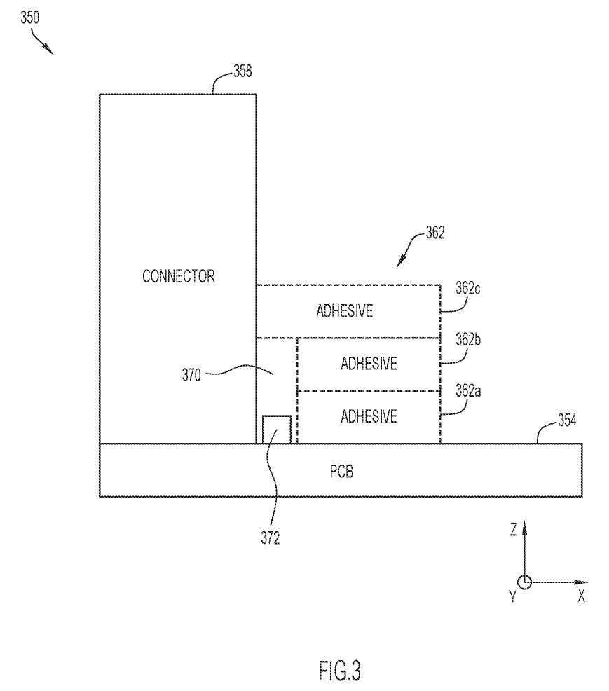

As previously mentioned, a clearance, gap, or void defined by a three-dimensional structure, PCB, and connector may be formed such that adhesive from the three-dimensional structure does not contact a feature on the PCB. FIG. 3 is a block diagram representation of a first side view of a PCB assembly that includes an adhesive layer structure or stack that defines a clearance, gap, or void around a feature of a PCB of the PCB assembly in accordance with an embodiment. In a PCB assembly 350, an adhesive layer structure 362 or stack is formed from adhesive layers 362a-c that are configured such that adhesive layer 362c is in contact with and adhered to a connector 358, while adhesive layer 362a is adhered to a PCB 354. Adhesive layer structure 362 may effectively affix connector 358 to PCB 354 at an edge of PCB 354, as for example at an approximately ninety degree angle.

A void 370 is defined by connector 358, PCB 354, a portion of a bottom surface of adhesive layer 362c, a side surface of adhesive layer 362a, and a side surface of adhesive layer 362b. It should be appreciated that void 370 may be referred to as a clearance, gap, empty area, empty volume, space, etc. A feature 372 on PCB 354 is located within void 370 such that adhesive from structure 362 effectively does not come into contact with feature 372. Feature 372 may be, for example, a pad or a through-hole. Structure 362 is formed to provide support that couples connector 358 to PCB 354 substantially without interfering with or otherwise coming into physical contact with feature 372.

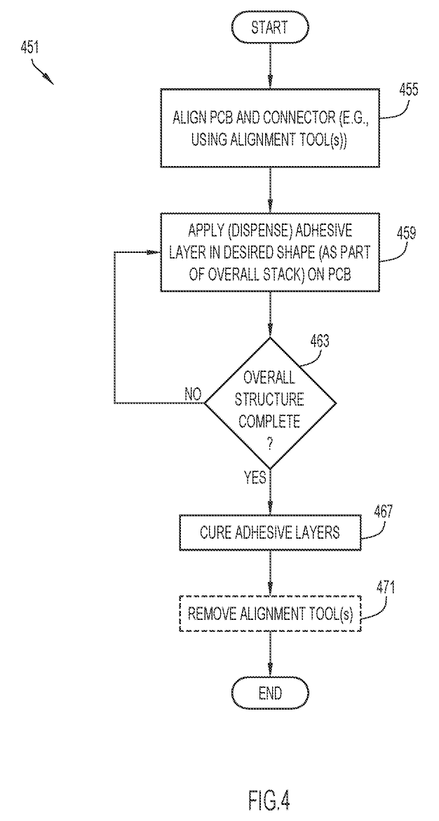

Referring next to FIG. 4, a method of creating a PCB assembly that includes a three-dimensional structure or stack formed from adhesive layers will be described in accordance with an embodiment. A method 451 of creating a PCB assembly that includes at least one structure formed from layers of adhesive or adhesive layers begins at a step 455 in which a PCB and a connector are aligned. Aligning the PCB and the connector may generally include positioning the connector with respect to the PCB, as for example along an edge of the PCB. The PCB and the connector may be positioned at an edge of the PCB such that the connector is at an approximately ninety degree angle with respect to the PCB. In one embodiment, an alignment tool may be used to effectively hold the PCB and the connector together in a desired alignment. It should be appreciated that the use of an alignment tool is optional, and that the alignment of the PCB with respect to the connector may be accomplished using any suitable method, e.g., press-fit pins on the connector with corresponding features or openings on the PCB.

In a step 459, an adhesive layer is applied or dispensed such that the adhesive layer takes on a desired shape. That is, an adhesive layer that is part of a three-dimensional adhesive structure or stack that is arranged to substantially secure or otherwise hold the connector and the PCB together is formed. Forming the adhesive layer, or the dispense layer, may generally include, but is not limited to including, dispensing an adhesive material using a dispensing tool at a desired location with respect to the PCB and the connector. As previously mentioned, the adhesive material may be any suitable material, e.g., a temperature stable material with a relatively high viscosity. Suitable materials may include, but are not limited to including, glue, epoxy, etc. It should be appreciated that the overall shape of a stack may vary widely, and the adhesive layer may be applied to further the creation of the overall shape. In one embodiment, an adhesive material may be dispensed in the shape of a strip, block, or similar shape that generally has a height, a width, and a length by a dispensing tool that includes a tip, e.g., a nozzle, through which the adhesive material may be dispensed or otherwise provided onto a PCB. Additionally, the amount of adhesive material dispensed to create the layer may be controlled, e.g., in up to approximately three dimensions. For instance, the amount and level of adhesive material dispensed may be adjusted to accommodate features including, but not limited to including, voids and/or structures on the PCB or the connector of the PCB assembly. That is, the dispensing of adhesive material may effectively be controlled to enable adjustments to be made to avoid features located on the PCB.

After the adhesive layer is applied or dispensed, a determination is made as to whether the structure is complete in a step 463. In other words, it is determined whether an additional adhesive layer or dispense layer is to be added to the structure in order to achieve an overall desired shape and size for the stack.

If the determination in step 463 is that the structure is not complete, the indication is that at least one additional adhesive layer is to be added to the structure. Accordingly, process flow returns to step 459 in which another adhesive layer is applied to the structure.

Alternatively, if it is determined that the structure is complete, the implication is that the desired three-dimensional shape and size of the structure has been completed or achieved. As such, process flow moves from step 463 to a step 467 in which the adhesive layers in the structure are cured. Curing the adhesive in the adhesive layers may generally cause a chemical process to effectively harden, as for example crystallize, the adhesive such that the adhesive layers may effectively form a completed structure. Any suitable curing process may generally be used to cure the adhesive layers. Suitable curing processes include, but are not limited to including, thermal curing and ultraviolet curing. Once the adhesive layers are cured, in an optional step 471, if an alignment tool was used to effectively hold the PCB and the connector together in a desired alignment, the alignment tool may be removed, and the method of creating a PCB assembly that includes at least one structure formed from adhesive layers is completed.

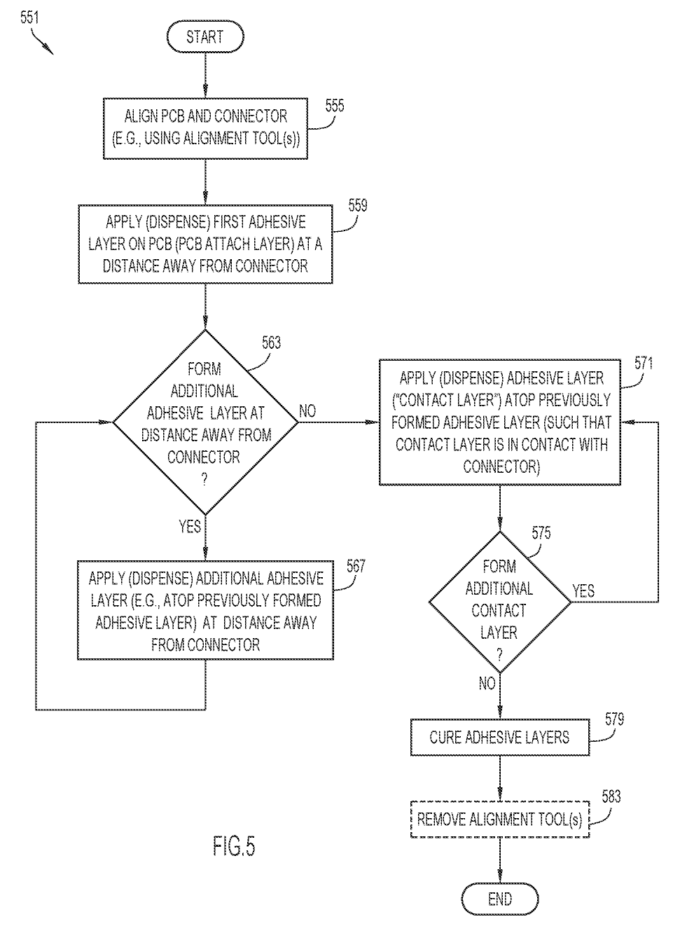

As previously discussed with reference to FIGS. 2A and 2B, a three-dimensional structure may be configured to define an opening or a void therein. FIG. 5 is a process flow diagram which illustrates a method of creating a PCB assembly that includes an adhesive layer structure that defines a void in accordance with an embodiment. A method 551 of creating a PCB assembly begins at a step 555 in which a PCB and a connector that are to be included in the PCB assembly are aligned, as for example using one or more alignment tools. The PCB and the connector may be aligned at an approximately ninety degree angle, with the connector positioned along an edge of the PCB.

Once the PCB and the connector are aligned or otherwise positioned relative to one another, a first adhesive layer of a three-dimensional structure is applied or dispensed on the PCB at a distance away from the connector in a step 559. The first adhesive layer, or a PCB attach layer that is substantially directly attached to the PCB, is dispensed on the PCB at a distance away from the connector to enable a void to be created between the connector and at least the first adhesive layer. That is, the void defined between the connector and a first side of the first adhesive layer may have a width that is approximately equal to the distance.

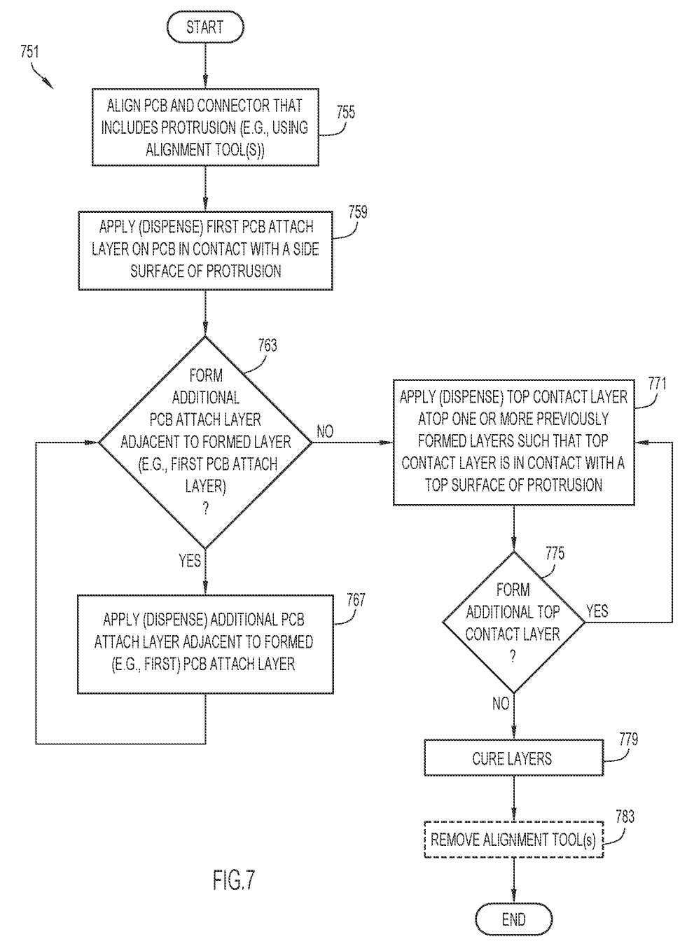

A determination is made in a step 563 as to whether an additional adhesive layer is to be formed at a distance away from the connector. In one embodiment, such a determination may include determining whether an additional layer is to be formed atop the first adhesive layer at the distance away from the connector. It should be appreciated that in some instances, as will be discussed below with respect to FIG. 7, such a determination may include ascertaining whether additional layers are to be created as additional PCB attach layers such that the additional layers are adjacent to at least the first adhesive layer.

If it is determined in step 563 that an additional adhesive layer is to be formed at a distance away from the connector, process flow moves to a step 567 in which an additional adhesive layer is applied at a distance away from the connector. For example, an additional adhesive layer may be formed atop the previously formed adhesive layer at approximately the same distance away from the connector. Once the additional adhesive layer is applied, process flow returns to step 563 in which it is determined whether another additional adhesive layer is to be formed at a distance away from the connector.

Alternatively, if it is determined in step 563 that no additional adhesive layer is to be formed at a distance away from the connector, the indication is that an adhesive layer or contact layer that contacts the connector is to be formed, as for example over a defined void. Accordingly, in a step 571, an adhesive layer, e.g., a contact layer, is formed atop a previously formed adhesive layer such that the adhesive layer is in contact with the connector.

After the adhesive layer or contact layer is formed atop the previously formed layer, it is determined in a step 575 whether an additional contact layer is to be formed. If it is determined that an additional contact layer is to be formed, process flow returns to step 571 in which an adhesive layer or contact layer is formed atop the previously formed adhesive layer. If, on the other hand, it is determined in step 575 that no additional contact layer is to be formed, the adhesive layers in the structure are cured in a step 579. Once the adhesive layers are cured, one or more alignment tools, if used to align the PCB and the connector, are removed in an optional step 583, and the method of creating a PCB assembly is completed.

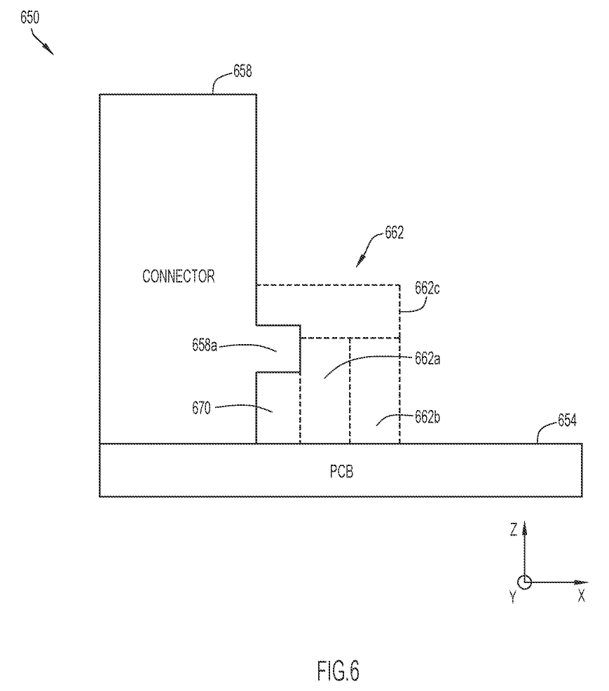

To facilitate the creation of a three-dimensional structure or stack from adhesive layer, structures such as scaffolds may be provided to facilitate the positioning, as for example stacking, of layers to create a three-dimensional structure or stack. In one embodiment, a connector may include a protrusion feature, shelf, ledge, or lip that may facilitate defining a void or other empty space associated with a three-dimensional structure or stack. FIG. 6 is a block diagram representation of a PCB assembly that includes a connector with a protrusion feature that is configured to provide structure or a shape to an adhesive layer structure in accordance with an embodiment. A PCB assembly 650 includes a PCB 654 and a connector 658 which are coupled to each other using a structure 662 that includes adhesive layers 662a-c.

Connector 658 includes a protrusion feature 658a or an edge bond offset protrusion feature that protrudes from a side of connector 658. In general, protrusion feature 658a may be of any size and shape. In one embodiment, protrusion feature 658a may be relatively small when compared to the size of connector 658, as for example less than approximately 0.75 millimeters in width relative to an x-axis when connector 658 has a width of approximately 33.5 millimeters, although it should be appreciated that the size of protrusion feature 658a may vary widely. Protrusion feature 658a provides an overhang such that a gap or a void 670 may be defined or otherwise formed underneath protrusion feature 658a. Void 670 may be provided to substantially prevent any of layers 662a-c from effectively impinging on the area of PCB under void 670.

As shown, a first layer 662a is attached or adhered to protrusion feature 658a, and a second layer 662b layer may be adjacent to first layer 662a relative to the x-axis, and adhered to first layer 662a. That is, both first layer 662a and second layer 662b may be PCB contact layers formed on PCB 654 such that a surface of first layer 662a and a surface of second layer 662b are in contact with PCB 654. A third layer 662c may be stacked substantially atop first layer 662a, second layer 662b, and protrusion feature 658a. Protrusion feature 658a may serve as a support structure that supports first layer 662a and third layer 662c such that void 670 may be maintained. As shown, a part of a surface of first layer 662a may be formed against a surface of protrusion feature 658a while another part of the surface of first layer 662a is displaced from a surface of connector 658, and one or more surfaces of third layer 662c may be formed against one or more surfaces of protrusion feature 658a. It should be appreciated that although first layer 662a and second layer 662b are shown in a substantially horizontal orientation, first layer 662a and second layer 662b may instead be formed in a substantially vertical orientation, e.g., as side-by-side verticals.

In general, a three-dimensional structure or a stack may include layers which are stacked relative to a z-axis, and/or layers which may be adjacent to each other relative to an x-axis or a y-axis. That is, a three-dimensional structure may include either or both vertically-oriented and horizontally-oriented stacks. As such, while structure 662 has been described as including first layer 662a and second layer 662b which are adjacent to each other relative to an x-axis, it should be appreciated that first layer 662a and second layer 662b may instead be stacked relative to a z-axis.

With reference to FIG. 7, a method of creating a three-dimensional structure or stack that leverages the use of a protrusion feature of a connector will be described in accordance with an embodiment. A method 751 of creating a PCB assembly begins at a step 755 in which a PCB and a connector that are to be included in the PCB assembly are aligned, as for example using one or more alignment tools.

Once the PCB and the connector are aligned or otherwise positioned relative to one another, a first PCB attach layer of a three-dimensional structure is applied or dispensed on the PCB in contact with a side surface of a protrusion on the connector in a step 759. In one embodiment, part of the first PCB attach layer is in contact with the protrusion, and part of the first PCB attach layer is offset from a surface of the connector. For example, a surface of the first PCB attach layer may cooperate with the connector, the protrusion, and the PCB to effectively define a void.

A determination is made in a step 763 as to whether an additional PCB attach layer is to be formed adjacent to an already formed layer, e.g., the first PCB attach layer. If the determination is that an additional PCB attach layer is to be formed, process flow moves to a step 767 in which an additional PCB attach layer is applied adjacent to an already formed PCB attach layer. After the additional PCB attach layer is applied, process flow returns to step 763 in which it is determined whether another additional PCB attach layer is to be formed adjacent to a formed layer.

Alternatively, if it is determined in step 763 that no additional PCB attach layers are to be formed adjacent to a formed layer, the implication is that a top contact layer is to be formed over a top surface of the protrusion. As such, in a step 771, a top contact layer is formed atop one or more previously formed layers, and atop a top surface of the protrusion. The top contact layer is also typically in contact with a side surface of the connector.

Once the top contact layer is formed, it is determined in a step 775 whether an additional top contact layer is to be formed. If the determination is that an additional top contact layer is to be formed, then process flow returns to step 771 in which another top contact layer is applied atop one or more previously formed top contact layers.

If the determination in step 775 is that no additional top contact layer is to be formed, then the layers in a structure are cured in a step 779, and any alignment tools used to align the connector and the PCB are removed in an optional step 783. Upon curing the layers in the structure, and optionally removing alignment tools, the method of creating a PCB assembly is completed.

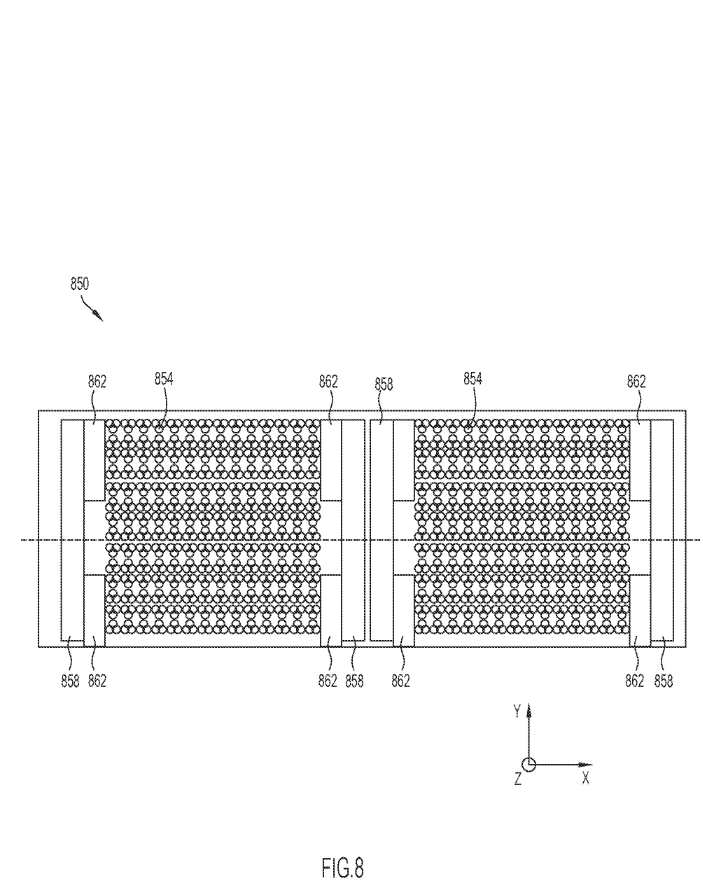

A PCB assembly may include one or more PCBs, as well as one or more connectors which are to be connected to or affixed to the one or more PCBs. In general, any number of three-dimensional structures or stacks may be positioned on a PCB to enable connectors to be affixed to the PCB. FIG. 8 is a diagrammatic top view representation of a PCB assembly plurality of PCBs and a plurality of connectors attached to the PCBs using adhesive layer structures in accordance with an embodiment. A PCB assembly 850 includes a plurality of PCBs 854 that may each be physically connected to connectors 858 using three-dimensional structures 862 formed from layers of adhesive. Three-dimensional structures 862 may each be arranged to connect each PCB 854 to at least one connector 858 at an approximately ninety degree angle. It should be appreciated that although structures 862 are shown as being located at edges of PCBs 854, structures 862 are not limited to being located at edges of PCBs 854. The surface finish of areas of PCBs 854 on which structures 862 are formed may be enhanced to facilitate the ability for the adhesive material used to form structures 862 to create a relatively strong bond with PCBs 854. The surface finish may include, but is not limited to including, a solder mask, a CU pad finish, and/or a plasma-treated solder mask.

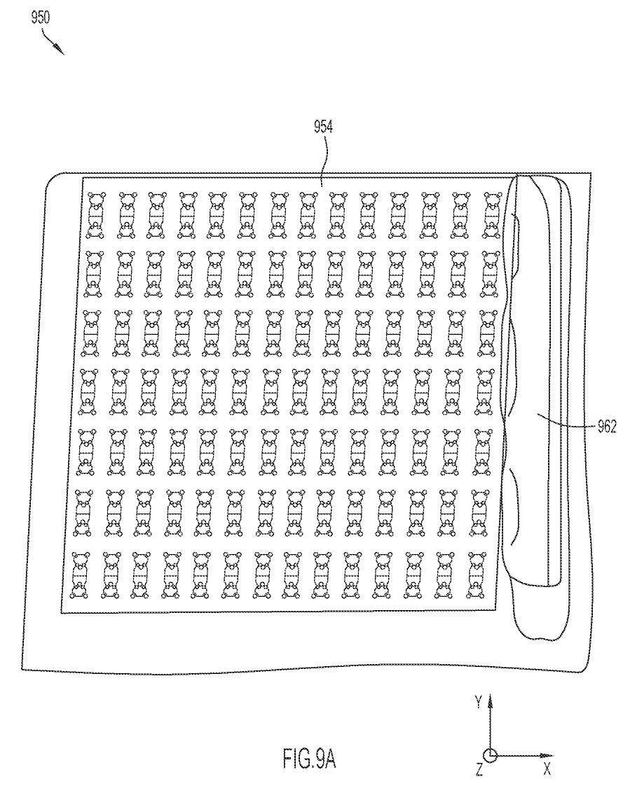

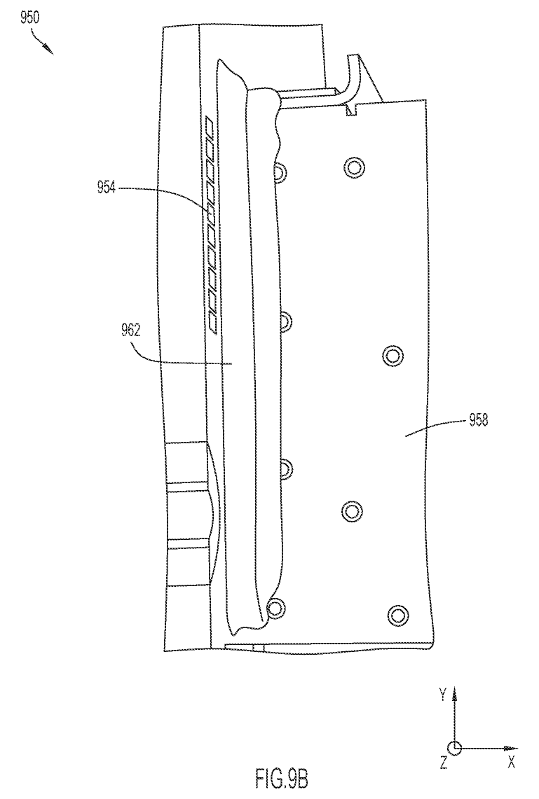

With reference to FIGS. 9A and 9B, a PCB assembly that includes a PCB and an adhesive layer structure will be described in accordance with an embodiment. As shown in FIG. 9A, a PCB assembly 950 may include a PCB 954 and an adhesive structure 962 or stack. Adhesive structure 962 may be positioned on an edge of PCB 954 to attach to a connector (not shown) which may be oriented at approximately a ninety degree angle with PCB 954. It should be appreciated that adhesive structure 962 is generally not created or otherwise positioned on PCB 954 until a connector 958 is aligned with PCB 954, as shown in FIG. 9B. It should be appreciated that PCB 954 is shown in FIG. 9A without connector 958 for ease of illustration. Connector 958, as shown in FIG. 9A, is attached to adhesive structure 9such that adhesive structure 962 effectively affixes connector 958 to an edge of PCB 954.

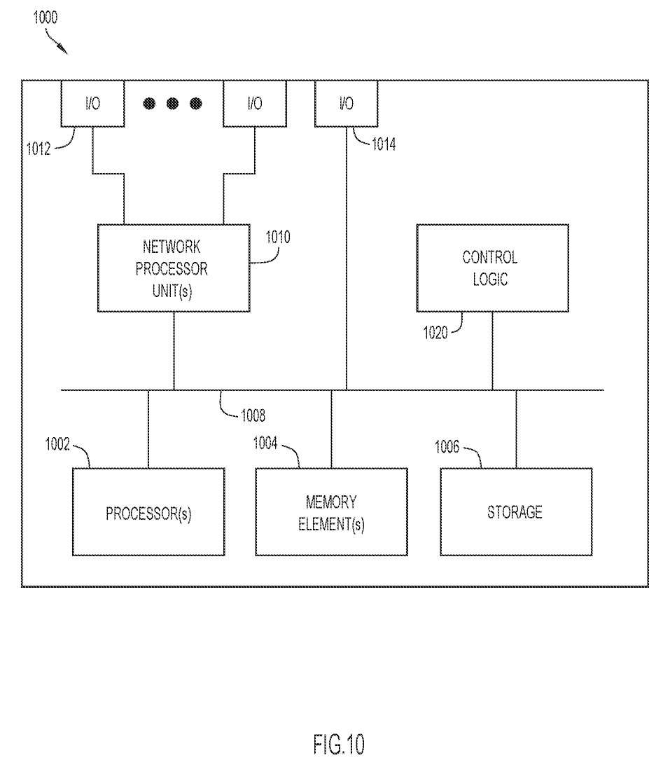

Referring next to FIG. 10, FIG. 10 illustrates a hardware block diagram of a computing device that may include a PCB assembly referred to herein in fabricated in accordance with the techniques depicted in FIGS. 1A,1B, 2A, 2C, 3-8, 9A, and 9B.

In at least one embodiment, the computing device 1000 may be any apparatus that may include one or more processor(s) 1002, one or more memory element(s) 1004, storage 1006, a bus 1008, one or more network processor unit(s) 1010 interconnected with one or more network input/output (I/O) interface(s) 1012, one or more I/O interface(s) 1014, and control logic 1020. In various embodiments, instructions associated with logic for computing device 1000 can overlap in any manner and are not limited to the specific allocation of instructions and/or operations described herein.

In at least one embodiment, processor(s) 1002 is/are at least one hardware processor configured to execute various tasks, operations and/or functions for computing device 1000 as described herein according to software and/or instructions configured for computing device 1000. Processor(s) 1002 (e.g., a hardware processor) can execute any type of instructions associated with data to achieve the operations detailed herein. In one example, processor(s) 1002 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term 'processor'.

In at least one embodiment, memory element(s) 1004 and/or storage 1006 is/are configured to store data, information, software, and/or instructions associated with computing device 1000, and/or logic configured for memory element(s) 1004 and/or storage 1006. For example, any logic described herein (e.g., control logic 1020) can, in various embodiments, be stored for computing device 1000 using any combination of memory element(s) 1004 and/or storage 1006. Note that in some embodiments, storage 1006 can be consolidated with memory element(s) 1004 (or vice versa), or can overlap/exist in any other suitable manner.

In at least one embodiment, bus 1008 can be configured as an interface that enables one or more elements of computing device 1000 to communicate in order to exchange information and/or data. Bus 1008 can be implemented with any architecture designed for passing control, data and/or information between processors, memory elements/storage, peripheral devices, and/or any other hardware and/or software components that may be configured for computing device 1000. In at least one embodiment, bus 1008 may be implemented as a fast kernel-hosted interconnect, potentially using shared memory between processes (e.g., logic), which can enable efficient communication paths between the processes.

In various embodiments, network processor unit(s) 1010 may enable communication between computing device 1000 and other systems, entities, etc., via network I/O interface(s) 1012 (wired and/or wireless) to facilitate operations discussed for various embodiments described herein. In various embodiments, network processor unit(s) 1010 can be configured as a combination of hardware and/or software, such as one or more Ethernet driver(s) and/or controller(s) or interface cards, Fibre Channel (e.g., optical) driver(s) and/or controller(s), wireless receivers/ transmitters/transceivers, baseband processor(s)/modem(s), and/or other similar network interface driver(s) and/or controller(s) now known or hereafter developed to enable communications between computing device 1000 and other systems, entities, etc. to facilitate operations for various embodiments described herein. In various embodiments, network I/O interface(s) 1012 can be configured as one or more Ethernet port(s), Fibre Channel ports, any other I/O port(s), and/or antenna(s)/antenna array(s) now known or hereafter developed. Thus, the network processor unit(s) 1010 and/or network I/O interface(s) 1012 may include suitable interfaces for receiving, transmitting, and/or otherwise communicating data and/or information in a network environment.

I/O interface(s) 1014 allow for input and output of data and/or information with other entities that may be connected to computing device 1000. For example, I/O interface(s) 1014 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 1020 can include instructions that, when executed, cause processor(s) 1002 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1020) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term 'memory element'. Data/information being tracked and/or sent to one or more entities as discussed herein could be provided in any database, table, register, list, cache, storage, and/or storage structure: all of which can be referenced at any suitable timeframe. Any such storage options may also be included within the broad term 'memory element' as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 1004 and/or storage 1006 can store data, software, code, instructions (e.g., processor instructions), logic, parameters, combinations thereof, and/or the like used for operations described herein. This includes memory element(s) 1004 and/or storage 1006 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In some aspects, the techniques described herein relate to a method including: aligning a printed circuit board (PCB) and a connector; dispensing a plurality of layers of an adhesive material, wherein the plurality of layers of the adhesive material form a structure that attaches the PCB and the connector, wherein the plurality of layers of the adhesive material cooperate with the PCB and the connector to define a void; and curing the plurality of layers of the adhesive material to harden the structure.

In some aspects, the techniques described herein relate to a method wherein the plurality of layers of the adhesive material includes a first PCB attach layer, and wherein dispensing the plurality of layers of the adhesive material includes dispensing the first PCB attach layer onto the PCB.

In some aspects, the techniques described herein relate to a method wherein dispensing the first PCB attach layer onto the PCB includes dispensing the first PCB attach layer onto the PCB at a distance away from the connector, and wherein the void is defined between the first PCB attach layer and the connector.

In some aspects, the techniques described herein relate to a method wherein the plurality of layers of the adhesive material include a second layer, and wherein dispensing the plurality of layers of the adhesive material includes dispensing the second layer over the first PCB attach layer.

In some aspects, the techniques described herein relate to a method wherein the second layer is in contact with a surface of the connector.

In some aspects, the techniques described herein relate to a method wherein the plurality of layers of the adhesive material include a second PCB attach layer, and wherein dispensing the plurality of layers of the adhesive material includes dispensing the second PCB attach layer on the PCB adjacent to the first PCB attach layer.

In some aspects, the techniques described herein relate to a method wherein the plurality of layers of the adhesive material include a third layer, and wherein dispensing the plurality of layers of the adhesive material includes dispensing the third layer over the first PCB attach layer and over the second PCB attach layer.

In some aspects, the techniques described herein relate to a method wherein aligning the PCB and the connector includes positioning the connector at an edge of the PCB.

In some aspects, the techniques described herein relate to an apparatus including: a printed circuit board (PCB); a connector; and a structure configured to couple the connector to the PCB, wherein the structure includes a plurality of layers formed from an adhesive material, and wherein the plurality of layers is arranged to cooperate with the connector and the PCB to define a void in the structure.

In some aspects, the techniques described herein relate to an apparatus wherein the plurality of layers includes a first PCB attach layer, the first PCB attach layer being formed on the PCB at a distance from a first surface of the connector.

In some aspects, the techniques described herein relate to an apparatus wherein the plurality of layers includes a second layer, and wherein the second layer is formed atop the first PCB attach layer and is attached to the first surface of the connector.

In some aspects, the techniques described herein relate to an apparatus wherein the connector includes a protrusion, the protrusion having a side surface and a top surface, and wherein the first PCB attach layer is attached to the side surface and the second layer is further attached to the top surface.

In some aspects, the techniques described herein relate to an apparatus wherein the plurality of layers includes a second PCB attach layer, the second PCB attach layer being formed on the PCB adjacent to the first PCB attach layer.

In some aspects, the techniques described herein relate to an apparatus wherein the plurality of layers includes a third layer, wherein the third layer is formed atop the first PCB attach layer and atop the second PCB attach layer, the third layer being attached to the first surface of the connector.

In some aspects, the techniques described herein relate to an apparatus wherein the PCB includes a feature, and wherein the feature is positioned within the void.

In some aspects, the techniques described herein relate to an apparatus wherein the structure configured to couple the connector to the PCB is arranged to couple the connector to an edge of the PCB.

In some aspects, the techniques described herein relate to an apparatus including: a printed circuit board (PCB), the PCB including a first feature; a connector; and a three-dimensional structure configured to support the connector on the PCB, wherein the structure includes a plurality of adhesive layers, and wherein the plurality of adhesive layers is arranged to define a void, the void being arranged over the first feature.

In some aspects, the techniques described herein relate to an apparatus wherein the plurality of layers includes a first PCB attach layer, the first PCB attach layer being formed on the PCB at a distance from a first surface of the connector, wherein the first feature is positioned on the PCB between the first surface and the first PCB attach layer.

In some aspects, the techniques described herein relate to an apparatus wherein the plurality of layers includes a second layer, and wherein the second layer is formed atop the first PCB attach layer and is attached to the first surface of the connector.

In some aspects, the techniques described herein relate to an apparatus wherein the connector includes a protrusion, the protrusion having a side surface and a top surface, the protrusion being arranged over the first feature, wherein the first PCB attach layer is attached to the side surface and the second layer is further attached to the top surface.

In some aspects, the techniques described herein relate to a method including: aligning a printed circuit board (PCB) and a connector; dispensing a plurality of layers of an adhesive material, wherein the plurality of layers of the adhesive material form a structure that attaches the PCB and the connector, wherein the plurality of layers of the adhesive material cooperate with the PCB and the connector to define a void; and curing the plurality of layers of the adhesive material to harden the structure.

In some aspects, the techniques described herein relate to a method wherein the plurality of layers of the adhesive material includes a first PCB attach layer, and wherein dispensing the plurality of layers of the adhesive material includes dispensing the first PCB attach layer onto the PCB.

In some aspects, the techniques described herein relate to a method wherein dispensing the first PCB attach layer onto the PCB includes dispensing the first PCB attach layer onto the PCB at a distance away from the connector, and wherein the void is defined between the first PCB attach layer and the connector.

In some aspects, the techniques described herein relate to a method wherein the plurality of layers of the adhesive material include a second layer, and wherein dispensing the plurality of layers of the adhesive material includes dispensing the second layer over the first PCB attach layer.

In some aspects, the techniques described herein relate to a method wherein the second layer is in contact with a surface of the connector.

In some aspects, the techniques described herein relate to a method wherein the plurality of layers of the adhesive material include a second PCB attach layer, and wherein dispensing the plurality of layers of the adhesive material includes dispensing the second PCB attach layer on the PCB adjacent to the first PCB attach layer.

In some aspects, the techniques described herein relate to a method wherein the plurality of layers of the adhesive material include a third layer, and wherein dispensing the plurality of layers of the adhesive material includes dispensing the third layer over the first PCB attach layer and over the second PCB attach layer.

In some aspects, the techniques described herein relate to a method wherein aligning the PCB and the connector includes positioning the connector at an edge of the PCB.

In some aspects, the techniques described herein relate to an apparatus including: a printed circuit board (PCB); a connector; and a structure configured to couple the connector to the PCB, wherein the structure includes a plurality of layers formed from an adhesive material, and wherein the plurality of layers is arranged to cooperate with the connector and the PCB to define a void in the structure.

In some aspects, the techniques described herein relate to an apparatus wherein the plurality of layers includes a first PCB attach layer, the first PCB attach layer being formed on the PCB at a distance from a first surface of the connector.

In some aspects, the techniques described herein relate to an apparatus wherein the plurality of layers includes a second layer, and wherein the second layer is formed atop the first PCB attach layer and is attached to the first surface of the connector.

In some aspects, the techniques described herein relate to an apparatus wherein the connector includes a protrusion, the protrusion having a side surface and a top surface, and wherein the first PCB attach layer is attached to the side surface and the second layer is further attached to the top surface.

In some aspects, the techniques described herein relate to an apparatus wherein the plurality of layers includes a second PCB attach layer, the second PCB attach layer being formed on the PCB adjacent to the first PCB attach layer.

In some aspects, the techniques described herein relate to an apparatus wherein the plurality of layers includes a third layer, wherein the third layer is formed atop the first PCB attach layer and atop the second PCB attach layer, the third layer being attached to the first surface of the connector.

In some aspects, the techniques described herein relate to an apparatus wherein the PCB includes a feature, and wherein the feature is positioned within the void.

In some aspects, the techniques described herein relate to an apparatus wherein the structure configured to couple the connector to the PCB is arranged to couple the connector to an edge of the PCB.

In some aspects, the techniques described herein relate to an apparatus including: a printed circuit board (PCB), the PCB including a first feature; a connector; and a three-dimensional structure configured to support the connector on the PCB, wherein the structure includes a plurality of adhesive layers, and wherein the plurality of adhesive layers is arranged to define a void, the void being arranged over the first feature.

In some aspects, the techniques described herein relate to an apparatus wherein the plurality of layers includes a first PCB attach layer, the first PCB attach layer being formed on the PCB at a distance from a first surface of the connector, wherein the first feature is positioned on the PCB between the first surface and the first PCB attach layer.

In some aspects, the techniques described herein relate to an apparatus wherein the plurality of layers includes a second layer, and wherein the second layer is formed atop the first PCB attach layer and is attached to the first surface of the connector.

In some aspects, the techniques described herein relate to an apparatus wherein the connector includes a protrusion, the protrusion having a side surface and a top surface, the protrusion being arranged over the first feature, wherein the first PCB attach layer is attached to the side surface and the second layer is further attached to the top surface.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

Communications in a network environment can be referred to herein as 'messages', 'messaging', 'signaling', 'data', 'content', 'objects', 'requests', 'queries', 'responses', 'replies', etc. which may be inclusive of packets. As referred to herein and in the claims, the term 'packet' may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a 'payload', 'data payload', and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in 'one embodiment', 'example embodiment', 'an embodiment', 'another embodiment', 'certain embodiments', 'some embodiments', 'various embodiments', 'other embodiments', 'alternative embodiment', and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase 'at least one of', 'one or more of', 'and/or', variations thereof, or the like are open-ended expressions that are both conjunctive and disjunctive in operation for any and all possible combination of the associated listed items. For example, each of the expressions 'at least one of X, Y and Z', 'at least one of X, Y or Z', 'one or more of X, Y and Z', 'one or more of X, Y or Z' and 'X, Y and/or Z' can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms 'first', 'second', 'third', etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, 'first X' and 'second X' are intended to designate two 'X' elements that are not necessarily limited by any order, rank, importance, temporal sequence, or hierarchy of the two elements. Further as referred to herein, 'at least one of' and 'one or more of' can be represented using the '(s)' nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
aligning a printed circuit board (PCB) and a connector;
dispensing a plurality of layers of an adhesive material, wherein the plurality of layers of the adhesive material form a structure that attaches the PCB and the connector, wherein the plurality of layers of the adhesive material cooperate with the PCB and the connector to define a void; and
curing the plurality of layers of the adhesive material to harden the structure.

2. The method of claim 1 wherein the plurality of layers of the adhesive material includes a first PCB attach layer, and wherein dispensing the plurality of layers of the adhesive material includes dispensing the first PCB attach layer onto the PCB.

3. The method of claim 2 wherein dispensing the first PCB attach layer onto the PCB includes dispensing the first PCB attach layer onto the PCB at a distance away from the connector, and wherein the void is defined between the first PCB attach layer and the connector.

4. The method of claim 2 wherein the plurality of layers of the adhesive material include a second layer, and wherein dispensing the plurality of layers of the adhesive material includes dispensing the second layer over the first PCB attach layer.

5. The method of claim 4 wherein the second layer is in contact with a surface of the connector.

6. The method of claim 2 wherein the plurality of layers of the adhesive material include a second PCB attach layer, and wherein dispensing the plurality of layers of the adhesive material includes dispensing the second PCB attach layer on the PCB adjacent to the first PCB attach layer.

7. The method of claim 6 wherein the plurality of layers of the adhesive material include a third layer, and wherein dispensing the plurality of layers of the adhesive material includes dispensing the third layer over the first PCB attach layer and over the second PCB attach layer.

8. The method of claim 1 wherein aligning the PCB and the connector includes positioning the connector at an edge of the PCB.

9. An apparatus comprising:
a printed circuit board (PCB);
a connector; and
a structure configured to couple the connector to the PCB, wherein the structure includes a plurality of layers formed from an adhesive material, and wherein the plurality of layers is arranged to cooperate with the connector and the PCB to define a void in the structure.

10. The apparatus of claim 9 wherein the plurality of layers includes a first PCB attach layer, the first PCB attach layer being formed on the PCB at a distance from a first surface of the connector.

11. The apparatus of claim 10 wherein the plurality of layers includes a second layer, and wherein the second layer is formed atop the first PCB attach layer and is attached to the first surface of the connector.

12. The apparatus of claim 11 wherein the connector includes a protrusion, the protrusion having a side surface and a top surface, and wherein the first PCB attach layer is attached to the side surface and the second layer is further attached to the top surface.

13. The apparatus of claim 12 wherein the plurality of layers includes a second PCB attach layer, the second PCB attach layer being formed on the PCB adjacent to the first PCB attach layer.

14. The apparatus of claim 13 wherein the plurality of layers includes a third layer, wherein the third layer is formed atop the first PCB attach layer and atop the second PCB attach layer, the third layer being attached to the first surface of the connector.

15. The apparatus of claim 10 wherein the PCB includes a feature, and wherein the feature is positioned within the void.

16. The apparatus of claim 10 wherein the structure configured to couple the connector to the PCB is arranged to couple the connector to an edge of the PCB.

17. An apparatus comprising:
a printed circuit board (PCB), the PCB including a first feature;
a connector; and
a three-dimensional structure configured to support the connector on the PCB, wherein the structure includes a plurality of adhesive layers, and wherein the plurality of adhesive layers is arranged to define a void, the void being arranged over the first feature.

18. The apparatus of claim 17 wherein the plurality of adhesive layers includes a first PCB attach layer, the first PCB attach layer being formed on the PCB at a distance from a first surface of the connector, wherein the first feature is positioned on the PCB between the first surface and the first PCB attach layer.

19. The apparatus of claim 18 wherein the plurality of adhesive layers includes a second layer, and wherein the second layer is formed atop the first PCB attach layer and is attached to the first surface of the connector.

20. The apparatus of claim 19 wherein the connector includes a protrusion, the protrusion having a side surface and a top surface, the protrusion being arranged over the first feature, wherein the first PCB attach layer is attached to the side surface and the second layer is further attached to the top surface.
